(19) United States
(12) Patent Application Publication
(10) Pub. No.: US 2023/0356125 A1
(43) Pub. Date: Nov. 9, 2023

(54) FILTRATION UNIT FOR ASPIRATING INFECTIOUS AEROSOLS AND SPRAY DROPLETS EXPELLED FROM A PATIENT'S MOUTH AND METHOD FOR ASPIRATING SUCH INFECTIOUS AEROSOLS AND SPRAY DROPLETS

(71) Applicant: AIREAU QUALITE CONTROLE INC., Bois-des-Filion (CA)

(72) Inventors: Martin BRISEBOIS, St-Apollinaire (CA); Michel SIROIS, Lorraine (CA)

(21) Appl. No.: 17/923,021

(22) PCT Filed: May 6, 2020
(86) PCT No.: PCT/IB2021/053871

§ 371 Date: Nov. 3, 2022

Related U.S. Application Data
(60) Provisional application No. 63/021,037, filed on May 6, 2020.

(30) Foreign Application Priority Data
Feb. 25, 2021 (CA) 3,110,393

(51) Int. Cl. B01D 46/00; B01D 46/12

(52) U.S. Cl. CPC B01D 46/0002; B01D 46/0042; B01D 46/12; B01D 2273/30

(57) ABSTRACT

A filtration unit for aspirating infectious aerosols and spray droplets expelled from a patient's mouth is disclosed. The filtration unit has a housing defining an air inlet; an articulated tube assembly fluidly connected to the air inlet; a hood connected to the tube assembly; a fan disposed in the lower portion of the housing; and at least one filter disposed in the housing vertically above the fan and fluidly between the air inlet and at least one air outlet defined in the filtration unit. During operation of the fan, air flows sequentially through the hood, then through the articulated tube assembly, then through the air inlet into the housing, then through the at least one filter, and then out of the housing via the at least one air outlet. A method of using the filtration unit is also disclosed.

### CROSS-REFERENCE

The present application claims priority to U.S. Provisional Patent Application No. 63/021,037, filed May 6, 2020 and to Canadian Patent Application No. 3,110,393, filed Feb. 25, 2021, the entirety of both of which is incorporated herein by reference.

### FIELD OF TECHNOLOGY

The present technology relates to filtration units for aspirating infectious aerosols and spray droplets expelled from a patient's mouth and a method for aspirating such infectious aerosols and spray droplets.

### BACKGROUND

Many patients in hospitals, medical clinics and dental clinics cough and sneeze. As can be seen in FIG. 1 for a patient 10 laying on his back, should the mouth of the patient 10 not be covered, this can result in the spread of infectious aerosols and spray droplets (generally indicated by reference numeral 12 in FIG. 1) being expelled from the patients mouth in the region surrounding the patient, which can in turn infect others. Studies have shown that these can be spread over many meters.

These infectious aerosols and spray droplets can also be expelled from the patient's mouth during certain procedures which can cause the patient to cough and/or have a gag reflex. One example of such a procedure is tracheal intubation. During such procedures, the healthcare workers are in proximity to the patient which can increase the risk of transmission of a virus for example.

Although healthcare workers wear personal protective equipment against these when near such patients, additional protection can be beneficial.

There is thus a desire for a device that can help prevent the spread of infectious aerosols and spray droplets being expelled from a patient's mouth.

### SUMMARY

It is an object of the present technology to ameliorate at least some of the inconveniences present in the prior art.

The present technology provides a filtration unit for aspirating infectious aerosols and spray droplets expelled from a patient's mouth. The filtration unit has an articulated tube assembly with a hood provided at its end. The articulated tube assembly is mounted to a housing. A fan is mounted in a lower portion of the housing. Two filters are located above the fan. At least one outlet is provided in the filtration unit. In some embodiments, the articulated tube assembly is mounted to an upper portion of the housing and the at least one outlet is provided in the lower portion of the filtration unit.

To use the filtration unit, the fan is first turned on. The hood is then located near the patient's head using the articulated tube assembly. As a result, a low pressure region is created around the patient's head. Should the patient cough or sneeze, infectious aerosols and spray droplets are aspirated with air through the hood. These then travel through the articulated tube assembly and enter the housing. These then travel through the filters which removes infectious aerosols and spray particles from the air. The filtered air is then expelled through the outlet. In embodiments where the articulated tube assembly is mounted to the upper portion of the housing, the at least one outlet is provided in the lower portion of the filtration unit, and the filtered air exiting the filters then travels through the fan before being expelled through the outlet near the floor.

According to one aspect of the present technology, there is provided a filtration unit for aspirating infectious aerosols and spray droplets expelled from a patient's mouth. The filtration unit has a housing defining an air inlet, the air inlet being defined in an upper portion of the housing; an articulated tube assembly having a first end fluidly connected to the air inlet; a hood connected to a second end of the articulated tube assembly; a fan disposed in a lower portion of the housing; and at least one filter disposed in the housing vertically above the fan, vertically above at least one air outlet defined in a lower portion of the filtration unit, and vertically below the air inlet, the at least one filter being disposed fluidly between the air inlet and the at least one air outlet. During operation of the fan, air flowing sequentially through the hood, then through the articulated tube assembly, then through the air inlet into the upper portion of the housing, then through the at least one filter, then through the fan, and then out of the housing via the at least one air outlet.

According to some embodiments of the present technology, the housing has a top, a bottom and a plurality of side walls; the air inlet is defined in the top of the housing; and the at least one air outlet is defined in at least one side wall of the plurality of side walls.

According to some embodiments of the present technology, the at least one air outlet is two air outlets. The two air outlets are defined in opposite side walls of the plurality of side walls.

According to some embodiments of the present technology, the first end of the articulated tube assembly is connected to the top of the housing.

According to some embodiments of the present technology, the first end of the articulated tube assembly includes a rotating socket. The rotating socket is connected to the top of the housing. The rotating socket permits 360 degrees of rotation of the articulated tube assembly about a vertical axis relative to the housing.

According to some embodiments of the present technology, the articulated tube assembly has first, second and third flexible hoses; and first and second rigid tubes. The first rigid tube is connected between the first and second flexible hoses. The second rigid tube is connected between the second and third flexible hoses. The hood is connected to the third flexible hose.

According to some embodiments of the present technology, a handle is connected to one of the second rigid tube, the third flexible hose and the hood.

According to some embodiments of the present technology, the articulated tube assembly has: at least one first self-locking joint connecting the first rigid tube to the first end of the articulated tube assembly, the at least one self-locking joint being disposed externally of the first rigid tube and the first flexible hose; and at least one second self-locking joint connecting the first rigid tube to the second rigid tube, the at least one second self-locking joint being disposed externally of the first rigid tube, the second flexible hose and the second rigid tube.

According to some embodiments of the present technology, the fan has: a fan housing defining a fan inlet; fan blades disposed below the fan inlet; and a fan motor disposed below the fan blades, the fan motor being operatively connected to the fan blades.

According to some embodiments of the present technology, acoustic insulation disposed in the lower portion of the housing.

According to some embodiments of the present technology, at least one baffle wall extending vertically below the fan blades. A lower end of the at least one baffle wall is vertically lower than the at least one air outlet such that air flowing from the fan blades flows generally downward inside the at least one baffle wall, then flows generally outward under the lower end of the at least one baffle wall, then flows generally upward outside the at least one baffle wall, and then flows out of the housing via the at least one air outlet.

According to some embodiments of the present technology, the at least one filter includes a first filter and a second filter. The first filter is disposed vertically above the second filter.

According to some embodiments of the present technology, the first filter is a pre-filter; and the second filter is one of a high-efficiency particulate air (HEPA) filter and an ultra-low particulate air (ULPA) filter.

According to some embodiments of the present technology, a filter frame is disposed in the housing. The second filter is disposed in the filter frame. A flange is disposed in the housing above the filter frame. A compressible joint is connected to one of a top of the filter frame and a bottom of the flange. A lifting assembly moves the filter frame between a lowered position and a raised position. In the raised position, the compressible joint is compressed between the filter frame and the flange.

According to some embodiments of the present technology, the housing defines at least one access port for providing access to the fan and the at least one filter. The filtration unit also has: at least one door for selectively closing the at least one access port; and at least one compressible joint connected to one of the housing and the at least one door. When the at least one door is closed, the at least one compressible joint surrounds the at least one access port and is compressed between the at least one door and the housing.

According to some embodiments of the present technology, the housing defines at least one access port for providing access to the fan and the at least one filter. The filtration unit further comprises at least one door for selectively closing the at least one access port. The at least one air outlet is defined in one of the at least one door.

According to some embodiments of the present technology, a flange around the at least one air outlet. The flange is configured for connecting a pipe to the filtration unit.

According to some embodiments of the present technology, at least one grille is disposed in the at least one air outlet.

According to some embodiments of the present technology, a plurality of wheels is mounted to a bottom of the housing.

According to another aspect of the present technology, a method for aspirating infectious aerosols and spray droplets expelled from a patient's mouth using a filtration unit is provided. The filtration unit has: a housing defining an air inlet; an articulated tube assembly having a first end fluidly connected to the air inlet; a hood connected to a second end of the articulated tube assembly; a fan disposed in the housing; and at least one filter disposed in the housing vertically above the fan. The method comprises: powering the fan; locating the hood near a head of the patient for creating a low pressure region around the head of the patient; aspirating air from the region such that air flows sequentially through the hood, then through the articulated tube assembly, then through the air inlet into the upper portion of the housing; filtering infectious aerosols and spray droplets out of the air using the at least one filter as air flows generally downward through the at least one filter from the upper portion of the housing to the fan disposed in a lower portion of the housing; and expelling the filtered air flowing from the fan out of the housing via at least one air outlet defined in a lower portion of the filtration unit.

According to another aspect of the present technology, there is provided a filtration unit for aspirating infectious aerosols and spray droplets expelled from a patient's mouth. The filtration unit has a housing defining an air inlet; an articulated tube assembly having a first end fluidly connected to the air inlet; a hood connected to a second end of the articulated tube assembly; a fan disposed in a lower portion of the housing; and at least one filter disposed in the housing vertically above the fan, the at least one filter being disposed vertically between the air inlet and at least one air outlet defined in the filtration unit. The at least one filter is disposed fluidly between the air inlet and the at least one air outlet. During operation of the fan, air flows sequentially through the hood, then through the articulated tube assembly, then through the air inlet into the housing, then through the at least one filter, and then out of the housing via the at least one air outlet.

According to another aspect of the present technology, the housing has a top, a bottom and a plurality of side walls. The air inlet is defined in the top of the housing. The at least one air outlet is defined in at least one side wall of the plurality of side walls.

According to another aspect of the present technology, the at least one air outlet is two air outlets. The two air outlets are defined in opposite side walls of the plurality of side walls.

According to another aspect of the present technology, the first end of the articulated tube assembly is connected to the top of the housing.

According to another aspect of the present technology, a handle is connected to the articulated tube assembly.

According to another aspect of the present technology, the articulated tube assembly has 360 degrees of rotation about a vertical axis relative to the housing.

According to another aspect of the present technology, the articulated tube assembly has: first and second rigid tubes; at least one first self-locking joint operatively connecting the first rigid tube to the second rigid tube; and at least one second self-locking joint operatively connecting the second rigid tube to the hood.

According to another aspect of the present technology, the fan has: a fan housing defining a fan inlet; fan blades disposed below the fan inlet; and a fan motor disposed below the fan blades. The fan motor is operatively connected to the fan blades.

According to another aspect of the present technology, acoustic insulation is disposed in the lower portion of the housing.

According to another aspect of the present technology, at least one baffle wall extends vertically below the fan blades. A lower end of the at least one baffle wall is vertically lower than the at least one air outlet such that air flowing from the fan blades flows generally downward inside the at least one baffle wall, then flows generally outward under the lower end of the at least one baffle wall, then flows generally upward outside the at least one baffle wall, and then flows out of the housing via the at least one air outlet.

According to another aspect of the present technology, the at least one filter includes a first filter and a second filter. One of the first and second filters is disposed vertically above the other one of the first and second filters.

According to another aspect of the present technology, the first filter is a pre-filter; and the second filter is one of a high-efficiency particulate air (HEPA) filter and an ultra-low particulate air (ULPA) filter.

According to another aspect of the present technology, a filter frame is disposed in the housing. The second filter is disposed in the filter frame. A flange is disposed in the housing above the filter frame. A compressible joint connects to one of a top of the filter frame and a bottom of the flange. A lifting assembly moves the filter frame between a lowered position and a raised position. In the raised position, the compressible joint is compressed between the filter frame and the flange.

According to another aspect of the present technology, the housing defines at least one access port for providing access to the fan and the at least one filter. The filtration unit also has: at least one door for selectively closing the at least one access port; and at least one compressible joint connected to one of the housing and the at least one door. When the at least one door is closed, the at least one compressible joint surrounds the at least one access port and is compressed between the at least one door and the housing.

According to another aspect of the present technology, the housing defines at least one access port for providing access to the fan and the at least one filter. The filtration unit also has at least one door for selectively closing the at least one access port. The at least one air outlet is defined in one of the at least one door.

According to another aspect of the present technology, a flange is provided around the at least one air outlet. The flange is configured for connecting a pipe to the filtration unit.

According to another aspect of the present technology, at least one grille is disposed in the at least one air outlet.

According to another aspect of the present technology, a plurality of wheels is operatively connected to a bottom of the housing.

According to another aspect of the present technology, a method for aspirating infectious aerosols and spray droplets expelled from a patient's mouth using a filtration unit is provided. The filtration unit has: a housing defining an air inlet; an articulated tube assembly having a first end fluidly connected to the air inlet; a hood connected to a second end of the articulated tube assembly; a fan disposed in a lower portion of the housing; and at least one filter disposed in the housing vertically above the fan. The method comprises: powering the fan; locating the hood near a head of the patient for creating a low pressure region around the head of the patient; aspirating air from the region such that air flows sequentially through the hood, then through the articulated tube assembly, then through the air inlet; filtering infectious aerosols and spray droplets out of the air using the at least one filter as air flows generally vertically through the at least one filter; and expelling the filtered air flowing from the at least one filter out of the housing via at least one air outlet defined in the filtration unit.

According to another aspect of the present technology, there is provided a filtration unit for aspirating infectious aerosols and spray droplets expelled from a patient's mouth. The filtration unit has a housing defining an air inlet; an articulated tube assembly having a first end fluidly connected to the air inlet; a hood connected to a second end of the articulated tube assembly; a fan disposed in the housing; and at least one filter disposed in the housing. The air inlet is disposed on a first side of the at least one air filter. The fan is disposed on a second side of the at least one air filter. An air outlet is defined in a portion of the filtration unit downstream of the fan and on the second side of the at least one filter. The at least one filter is disposed fluidly between the air inlet and the at least one air outlet. During operation of the fan, air flows sequentially through the hood, then through the articulated tube assembly, then through the air inlet into the housing, then through the at least one filter, then through the fan, and then out of the housing via the at least one air outlet.

According to another aspect of the present technology, the housing has a top, a bottom and a plurality of side walls. The air inlet is defined in a first wall of the plurality of side walls. The at least one air outlet is defined in a second side wall of the plurality of side walls.

According to another aspect of the present technology, the first and second side walls are opposite to each other.

According to another aspect of the present technology, the first end of the articulated tube assembly is connected to the first side wall.

According to another aspect of the present technology, a rotating socket is configured for connecting at least a portion of the articulated tube assembly to at least one of a ceiling and a bottom portion of an interstitial space. The rotating socket permits 360 degrees of rotation of at least the portion of the articulated tube assembly about a vertical axis.

According to another aspect of the present technology, the articulated tube assembly has: first and second flexible hoses; and first and second rigid tubes. The first rigid tube is connected to the first flexible hose. The second rigid tube is connected between the first and second flexible hoses. The hood is connected to the second flexible hose.

According to another aspect of the present technology, a handle is connected to one of the second rigid tube and the hood.

According to another aspect of the present technology, the fan has: a fan housing defining a fan inlet; fan blades disposed downstream of the fan inlet; and a fan motor disposed downstream of the fan blades. The fan motor is operatively connected to the fan blades.

According to another aspect of the present technology, acoustic insulation is disposed in the portion of the housing housing the fan.

According to another aspect of the present technology, the at least one filter includes a first filter and a second filter. The first filter is disposed between the second filter and the air inlet.

According to another aspect of the present technology, the first filter is a pre-filter; and the second filter is one of a high-efficiency particulate air (HEPA) filter and an ultra-low particulate air (ULPA) filter.

According to another aspect of the present technology, the housing defines at least one access port for providing access to the fan and the at least one filter. The filtration unit also has: at least one door for selectively closing the at least one access port; and at least one compressible joint connected to one of the housing and the at least one door. When the at least one door is closed, the at least one compressible joint surrounds the at least one access port and is compressed between the at least one door and the housing.

According to another aspect of the present technology, the housing is adapted for mounting to at least one of a ceiling, a top of an interstitial space and the bottom of the interstitial space.

According to another aspect of the present technology, at least one bracket is provided for connecting the housing to the at least one of the ceiling, the top of the interstitial space and the bottom of the interstitial space.

According to another aspect of the present technology, the housing is adapted for mounting to the at least one of the top of the interstitial space and the bottom of the interstitial space, such that the housing is disposed in the interstitial space and at least a portion of the articulated tube assembly extends in a room below the interstitial space.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic representation of a patient laying on his back, with infectious aerosols and spray droplets being expelled from the patient's mouth as a result of the patient coughing or sneezing;

FIG. 2 is a schematic representation of a patient laying on his back, with infectious aerosols and spray droplets being expelled from the patient's mouth as a result of the patient coughing or sneezing with a hood of a filtration unit being located near a head of the patient to aspirate the infectious aerosols and spray droplets;

FIG. 3 is a perspective view, taken from a front, left side, of the filtration unit;

FIG. 4 is a perspective view, taken from a front, right side, of the filtration unit of FIG. 3;

FIG. 5 is a front elevation view of the filtration unit of FIG. 3;

FIG. 6 is partially exploded perspective view of the filtration unit of FIG. 3;

FIG. 7 is a cross-sectional view of the filtration unit of FIG. 3 taken through line 7-7 of FIG. 5;

FIG. 8 is a perspective view, taken from a front, left side, of a portion of the filtration unit of FIG. 3, with two doors of the filtration unit being removed and with filters being partially slid out of the housing;

FIG. 9 is a close-up front view of a portion of the filtration unit of FIG. 3, with the middle door being removed and a filter frame being in a raised position;

FIG. 10 is another close-up front view of the filtration unit of FIG. 3, with the doors and HEPA filter removed;

FIG. 11 is a close-up view of a lower portion of the filtration unit of FIG. 3, with the doors removed;

FIG. 12 is a right side view of a portion of the filtration unit of FIG. 3;

FIG. 13 is a partially disassembled lower perspective view a portion of a fan support and of a fan motor of the filtration unit of FIG. 3;

FIG. 14 is a perspective view of an alternative embodiment of an articulated tube assembly and hood of the filtration unit of FIG. 3;

FIG. 15 is a side elevation view of the articulated tube assembly and hood of FIG. 10, shown in two different positions;

FIG. 16 is a perspective view, taken from a front, right side, of an alternative embodiment of the filtration unit of FIG. 3;

FIG. 17 is a perspective view, taken from a rear, right side, of the filtration unit of FIG. 16;

FIG. 18 is a close-up perspective view, taken from a front right side, of a lower portion of the filtration unit of FIG. 16, with the lower door having been replaced with a lower door having a flange for connecting the filtration unit to external piping;

FIG. 19 is a schematic view of the filtration unit of FIG. 16 being used with a patient in a hospital bed; and

FIG. 20 is a schematic view of a room provided with an alternative embodiment of the filtration unit of FIG. 16 with a housing of the filtration unit mounted inside an interstitial space of the room, and with the doors of the filtration unit removed to show the internal components of the housing.

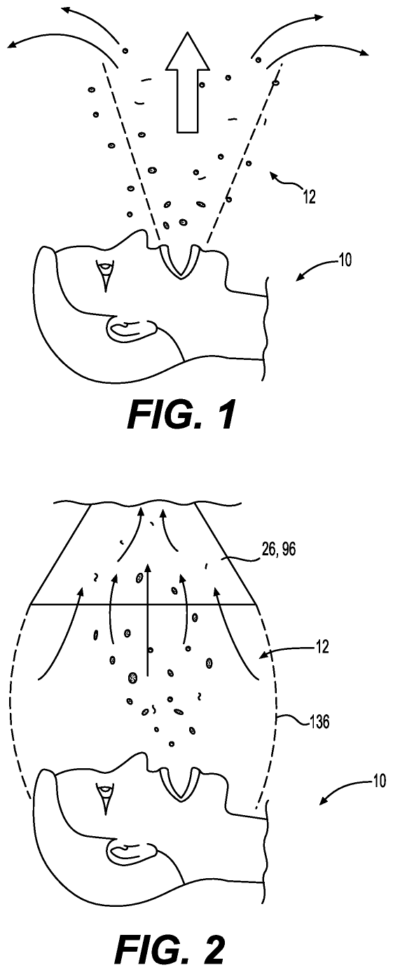

### DETAILED DESCRIPTION

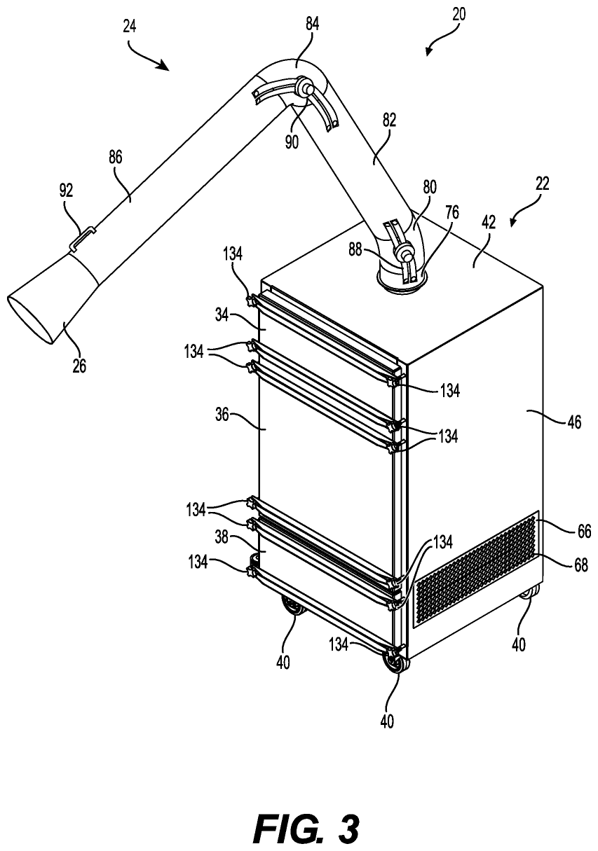

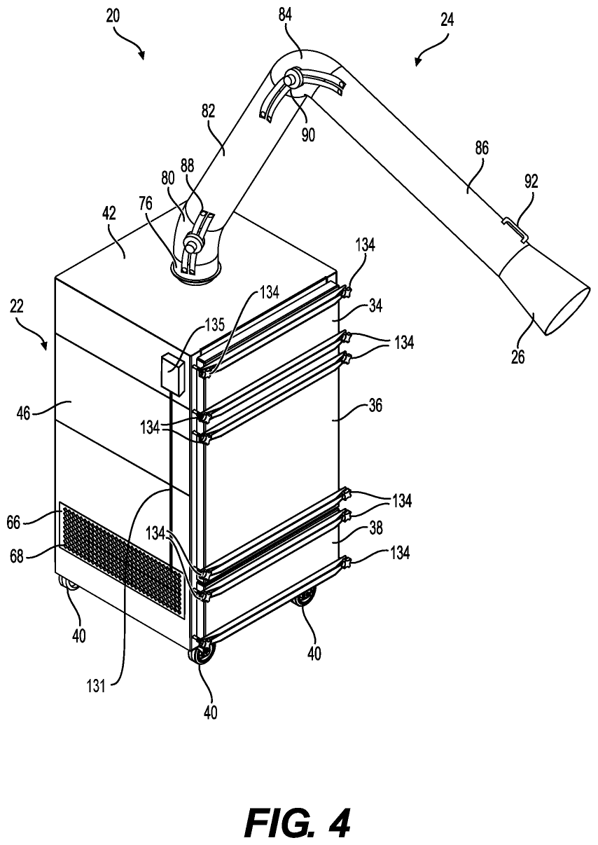

A filtration unit 20 suitable for aspirating infectious aerosols and spray droplets expelled from the mouth of a patient 10 (FIG. 2) will be described with reference to FIGS. 3 to 13.

The main components of the filtration unit 20 are a housing 22, an articulated tube assembly 24 connected to the housing 22, a hood 26 connected to an end of the articulated tube assembly 24, two filters 28, 30 disposed in the housing 22, a fan 32 disposed in the housing 22, three doors 34, 36, 38 for providing access to components disposed inside the housing 22, and four wheels 40 mounted to the bottom of the housing 22 for making the filtration unit 20 easily portable.

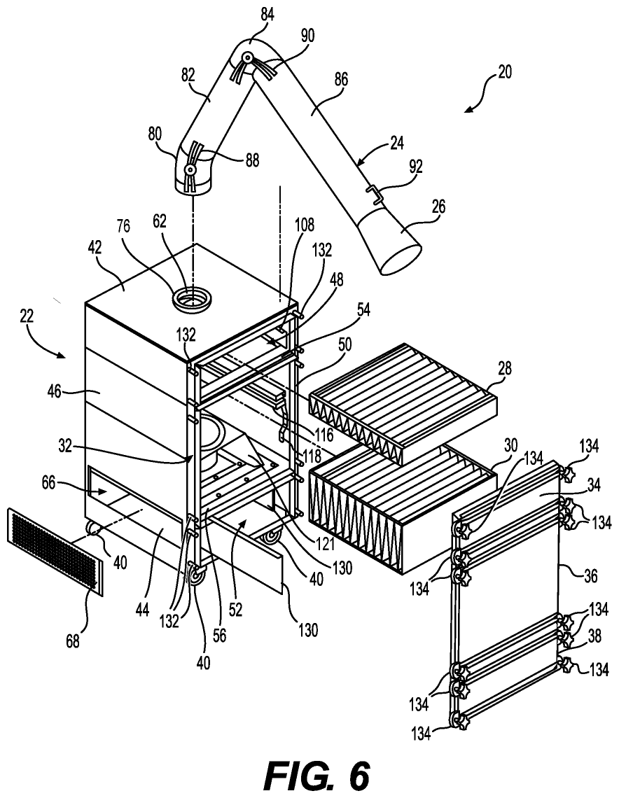

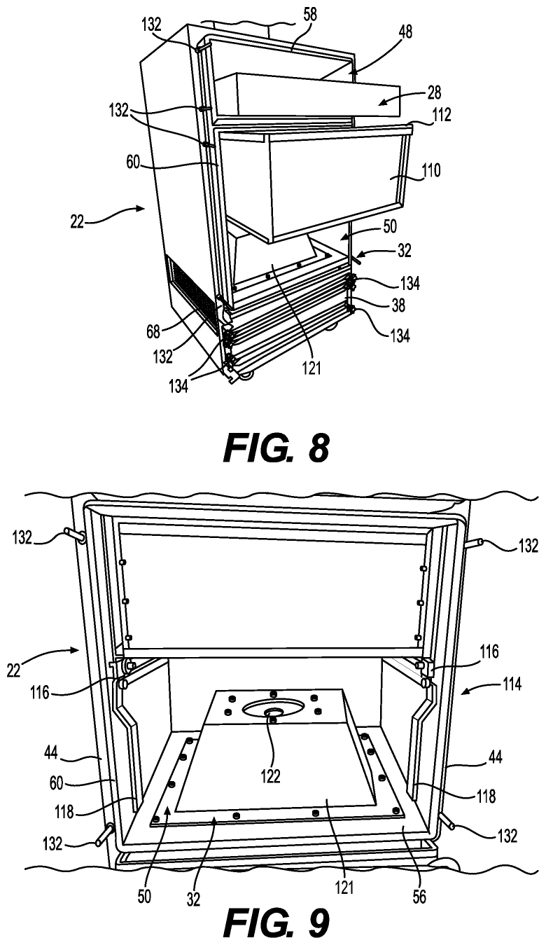

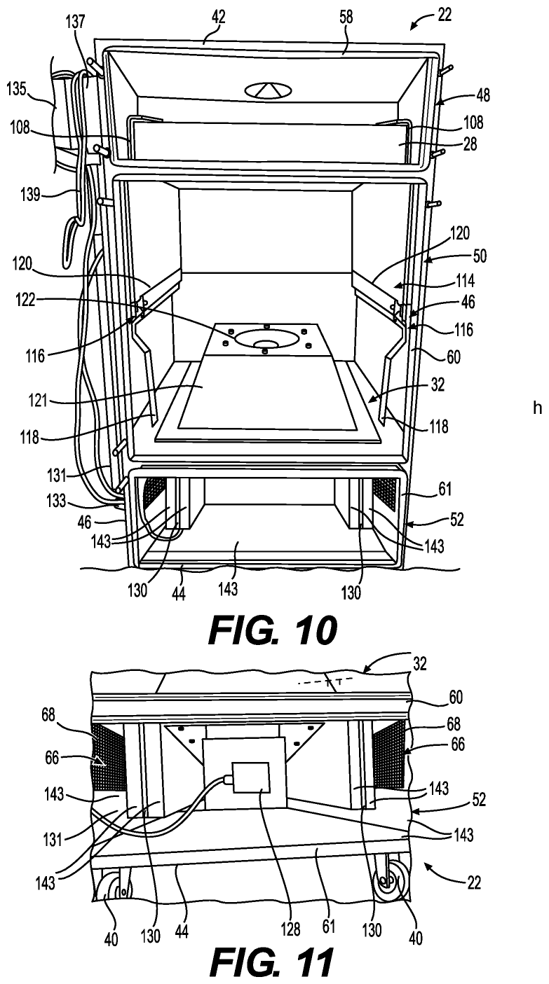

The housing 22 has a top 42, a bottom 44, and left, right, and rear side walls 46. A front of the housing 22 is generally opened. As best seen in FIG. 6, the front of the housing 22 defines three access ports 48, 50, 52. Each access port 48, 50, 52 is selectively closed by a corresponding one of the doors 34, 36, 38 respectively as will be described in more detail below. A filter support flange 54 is connected in the housing 22 in an upper portion thereof. The access port 48 is defined between the filter support flange and the top 42 of the housing 22. A fan support 56 is connected in the housing 22 in a lower portion thereof. The access port 50 is defined between the filter support flange 54 and the fan support 56. The access port 52 is defined between the fan support 56 and the bottom 44 of the housing 22. A compressible joint 58 (FIG. 8) is connected to the front of the housing 22 around the access port 48. A compressible joint 60 (FIG. 8) is connected to the front of the housing around the access port 50. A compressible joint 61 (FIG. 10) is connected to the front of the housing 22 around the access port 52. It is contemplated that one or more of the compressible joints 58, 60, 61 could be connected to its corresponding door 34, 36, 38 instead of to the front of the housing 22.

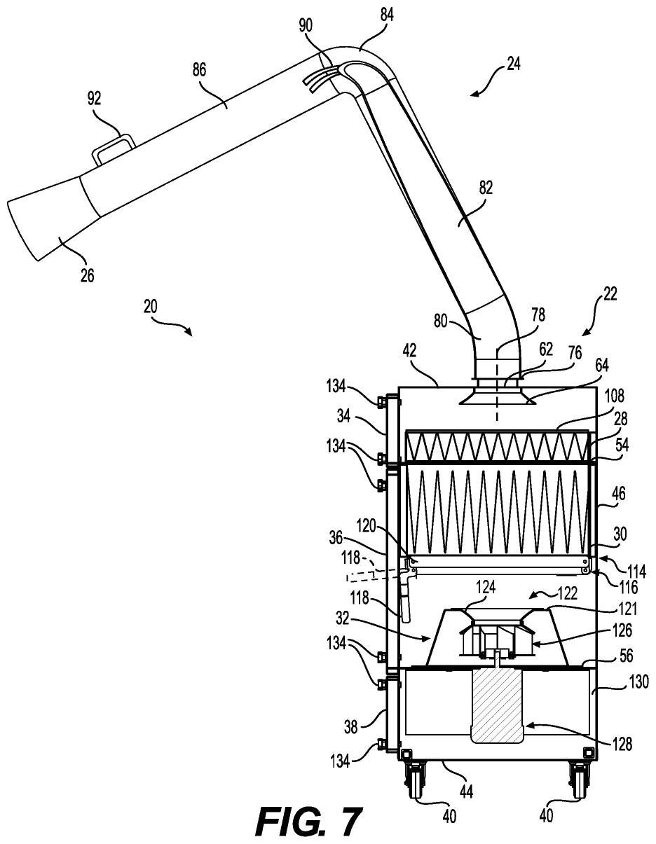

The housing 22 defines an air inlet 62 (FIG. 6) in an upper portion thereof. In the present embodiment, the air inlet 62 is defined in the center of the top 42 of the housing 20. As can be seen in FIG. 7, an air diffuser 64 is connected to the inside of the top 42 around the air inlet 62. The housing 22 defines two air outlets 66 in the lower portion of the housing 22. In the present embodiment, one air outlet 66 is defined in the left side wall 46 and the other air outlet 66 is defined in the right side wall 46. Both air outlets 66 are disposed vertically lower than the fan support 56. It is contemplated that only one air outlet 66 could be provided. It is also contemplated that more than two air outlets 66 could be provided. It is also contemplated that an air outlet 66 could be provided in the rear side wall 46. Each air outlet 66 has a grille 68 disposed therein. It is also contemplated that one of the air outlets 66 could be blocked such that air could exit only on one side of the housing 22. For example, it is contemplated that the air outlet 66 facing an air pickup port of a ventilation system of an operating room in which the filtration unit 20 is provided could be left open, while the other air outlet 66 is closed.

The components of the housing 22, other than the compressible joints 58, 60, 61 are made of stainless steel, but other materials are contemplated.

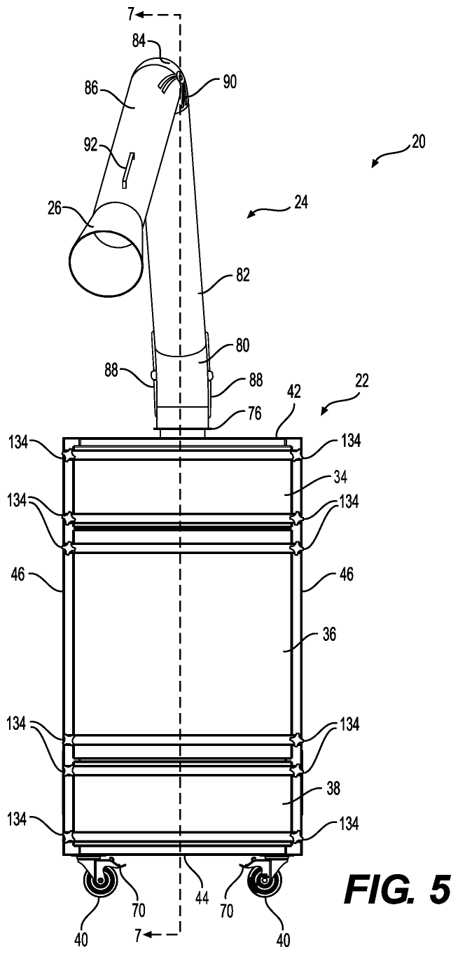

With reference to FIG. 5, the wheels 40 are pivotally connected to the bottom 44 so as to swivel relative to the housing 22. The wheels 40 allow the filtration unit 20 to be portable and to be used in different locations. Each wheel 40 is provided with a brake 70 that can be actuated by a user's foot to prevent the filtration unit 20 from moving while in use or when stored. It is contemplated that some or all the wheels 40 could not be provided with a brake 70. In one embodiment, the wheels 40 are certified for use in healthcare environment. It is contemplated that the wheels 40 could be omitted if, for example, the filtration unit 20 is intended to be used permanently in the same location.

The articulated tube assembly 24 is connected at one end to the top 42 of the housing 22 so as to be fluidly connected to the air inlet 62. The hood 26 is connected to the other end of the articulated tube assembly 24. The articulated tube assembly 24 has a rotating socket 76 that connects to the top 42 of the housing 22. The rotating socket 76 permits 360 degrees of rotation of the articulated tube assembly 24 about a vertical axis 78 (FIG. 7) relative to the housing 22. It is contemplated that the rotating socket 76 could also permit vertical movement of the articulated tube assembly 24 relative to the housing 22. It is contemplated that the rotating socket 76 could be omitted in some embodiments.

The articulated tube assembly 24 also has a flexible hose 80 connected to the rotating socket 76 at one end, a rigid tube 82 connected at one end to the other end of the flexible hose 80, a flexible hose 84 connected at one end to the other end of the rigid tube 82, and a rigid tube 86 connected at one end to the other end of the flexible hose 84. The hood 26 is connected to the other end of the rigid tube 86. The flexible hoses 80, 84 are connected to the rigid tubes 82, 86 and to the rotating socket 76 by gear clamps (not shown), but other types of connectors could be used. The rigid tubes 82, 86 are made of stainless steel, but other materials are contemplated. The flexible hoses 80, 84 are made from medical grade, Food and Drug Administration (FDA) approved transparent plastic, but other materials are contemplated. The rigid tubes 82, 86 and flexible hoses 80, 84 have a diameter of 5 inches, but other diameters are contemplated. Two self-locking joints 88 connect the rigid tube 82 to the rotating socket 76, and are disposed externally of the rotating socket 76, the flexible hose 80 and the rigid tube 82. Two self-locking joints 90 connect the rigid tube 82 to the rigid tube 86, and are disposed externally of the rigid tubes 82, 86 and the flexible hose 84. It is contemplated that only one self-locking joints 88 and only one self-locking joint 90 could be provided. A handle 92 is provided on the rigid tube 86 to facilitate manipulation of the articulated tube assembly 24. A user can change the position and orientation of the hood 26 by moving it using the handle 92 of the articulated tube assembly 24. Once the hood 26 is in the desired position and orientation, the user releases the handle 92 and the self-locking joints 88, 90 maintain the articulated tube assembly 24, and therefore the hood 24, in position. It is contemplated that the self-locking joints 88, 90 could be omitted, however the user may have to keep holding the hood 26 in the desired position and orientation while the filtration unit 20 is being used. By using gear clamps for providing the various connections and by disposing the self-locking joints 88, 90 externally, the interior of the articulated tube assembly 24 is free of obstacles that could impede the flow of air through the articulated tube assembly 24.

The hood 26 is frustoconical in shape and tapers from its free end toward the rigid tube 86. The hood 26 is made of stainless steel, but other materials are contemplated. The hood 26 has a diameter of 10.5 inches at its free end, but other diameters are contemplated. It is contemplated that an air diverter could be provided in the hood 26 to increase the flow of air therethrough. It is also contemplated that the hood 26 could be provided with a light. The power switch (not shown) of the fan 32 is provided on the hood 26. It is contemplated that the power switch could alternatively be provided on the articulated tube assembly 24 or on the housing 22.

In one embodiment, the combined length of the articulated tube assembly 24 and the hood 26 (i.e. when the articulated tube assembly 24 is straight) is 7 feet. In another embodiment, this combined length is 10 feet. It is contemplated that this combined length could be different in other embodiments.

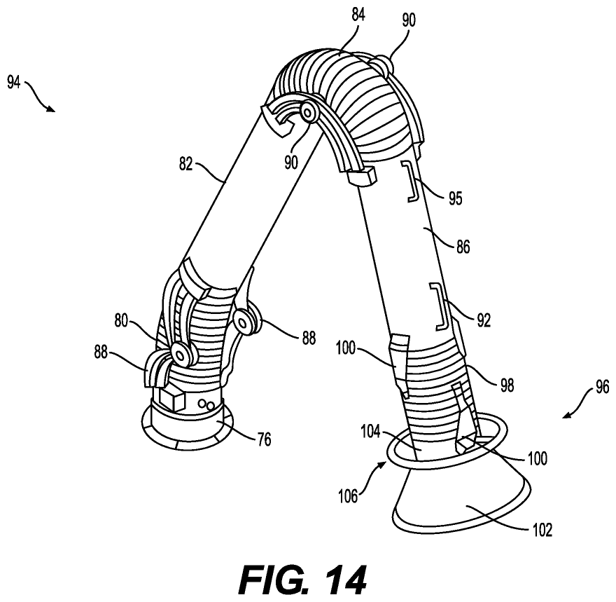

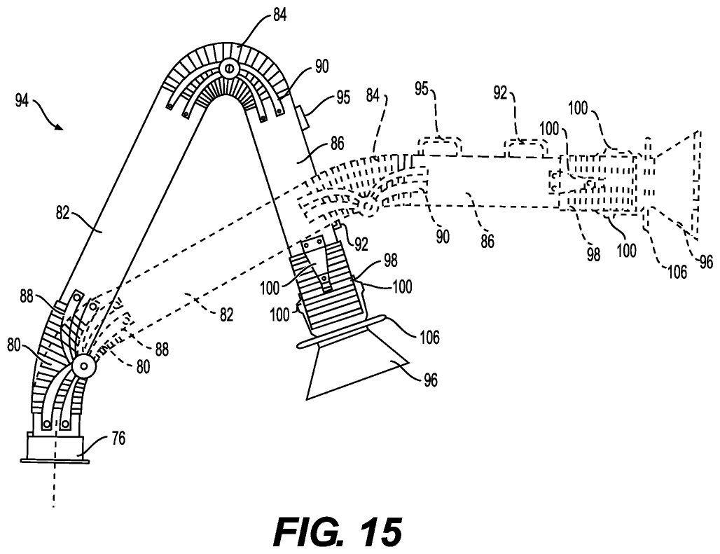

FIGS. 14 and 15 illustrate an articulated tube assembly 94 and a hood 96 that are alternative embodiments of the articulated tube assembly 24 and the hood 26. The articulated tube assembly 94 and the hood 96 are similar to the MAXAIR™ articulated fume extractor arm manufactured by Aireau Quality Control Inc. The articulated tube assembly 94 differs from the articulated tube assembly 24 by the addition of a flexible hose 98 and corresponding self-locking joints 100. The flexible hose 98 connects the end of the rigid tube 86 to the hood 96. The articulated tube assembly 94 therefore provides additional degrees of freedom for the orienting and positioning of the hood 96 by permitting swivelling of the hood 96 relative to the rigid tube 86. The other components of the articulated tube assembly 94 are the same as those of the articulated tube assembly 24. These have been labeled with the same reference numerals in FIGS. 14 and 15 and will not be described again. The hood 96 has a frustoconical portion 102 and a cylindrical portion 104 to permit the connection to the flexible hose 98. The flexible hose 98 is connected to the rigid tube 86 and the cylindrical portion 104 of the hood 96 by gear clamps, but other types of connectors are contemplated. A handle 95 is connected to the rigid tube 86 near the hose 84. A circular handle 106 is connected to the hood 96 to assist in its manipulation. It is contemplated that the handle 95 and/or the handle 106 could be omitted.

Returning to FIGS. 6 to 10, the filters 28, 30 will be described in more detail. The filter 28 is a pre-filter, more specifically MERV 14 air filter (Minimum Efficiency Reporting Value). Other types of filters and filters having a different MERV rating are contemplated. The filter 28 is slid into the housing 22 via the access port 48. The filter 28 sits on the filter support flange 54 and is held above by brackets 108 as best seen in FIG. 10. The filter 28 is disposed vertically above the air outlets 66, the fan 32 and the filter 30, and is disposed vertically below the air inlet 62. It is contemplated that the pre-filter 28 could be omitted. It is also contemplated that one or more ultraviolet (UV) lights could be provided in the housing 22 above the pre-filter 28 and/or between the pre-filter 28 and the filter 30 to assist in sterilization. It is contemplated that UV lights could also be provided elsewhere inside the housing 22.

The filter 30 is a high-efficiency particulate air (HEPA) filter. In an alternative embodiment, the filter is an ultra-low particulate air (ULPA) filter. The filter 30 is slid into the housing 22 via the access port 50. The filter 30 is disposed vertically above the air outlets 66 and the fan 32, and is disposed vertically below the air inlet 62, the air filter 28 and the filter support flange 54. As can be seen in FIGS. 8 and 9, the filter 30 is disposed inside a filter frame 110 that surrounds the filter on the front, rear, left and right sides. A compressible joint 112 is connected to the top of the filter frame 110. The filter frame 110 is slid into the housing 22 together with the filter 30. The filter frame 110 is supported inside the housing 22 by a lifting assembly 114. The lifting assembly 114 moves the filter frame 110 and the filter 30 between a lowered position and a raised position (shown in FIGS. 7 and 9). In the lowered position, the filter frame 110 and the filter 30 can be slid in and out of the housing 22. In the raised position, the compressible joint 112 is compressed between the filter frame 110 and the filter support flange 54. As a result, air flowing from the air inlet 62 to the air outlets 66 must flow through the filter 30. It is contemplated that in an alternative embodiment the compressible joint 112 could be connected to the bottom of the filter support flange 54.

In the present embodiment, the lifting assembly 114 consists of left and right four-bar linkages 116 which are mirror images of each other. With reference to FIGS. 7 and 10, it can be seen that one of the linkages of each of the four-bar linkages 116 defines a handle 118. To place the filter frame 110 and the filter 30 in the raised position, the handles 118 are pushed down so as to extend generally vertically as shown in FIGS. 7, 9 and 10. Pushing the handles 118 down lifts upper horizontal linkages 120 that lift the filter frame 110 and the filter 30 with them. To place the filter frame 110 and the filter 30 in the lowered position, the handles 118 pulled up so as to extend generally horizontally as shown in dotted lines in FIG. 7. Pulling the handles 118 up lowers upper horizontal linkages 120 which lowers the filter frame 110 and the filter 30 at the same time. As can be seen in FIG. 7, in the lowered position, the handles 118 extend out of the housing 22. As a result, the door 36 cannot be closed when the filter frame 110 and the filter 30 are in the lowered position. This helps ensure that the filtration unit 20 can only be operated when the filter frame 110 and the filter 30 are in the raised position.

It is contemplated that one or more pressure gauges can be used to determine the air pressure upstream and downstream of the filter 30 during operation of the filtration unit 20 to determine when the filter 30 needs to be replaced. In some embodiments, one 0 to 5 inches of water differential pressure gauge is used to compare the pressure upstream and downstream of the filter 30. Other types of pressure gauges are contemplated. Other types of sensors which could be used to determine when the filter 30 needs replacement are also contemplated. It is contemplated that a similar arrangement could be used to determine when the filter 28 needs to be replaced. It is also contemplated that the air pressure comparison could be made between the air pressure upstream of the filter 28 and the air pressure downstream of the filter 30.

It is contemplated that in some embodiments, the filter 30 could be replaced without having to touch the filter 30 directly. This can be achieved by providing what is commonly referred to as a bag-in/bag-out system. In such a system, a medical grade bag is connected to one side of the filter frame 110. When the filter 30 needs to be replaced, this bag is used to remove the filter 30 by placing the filter 30 directly in the bag (i.e. the user only touches the bag and not the filter 30).

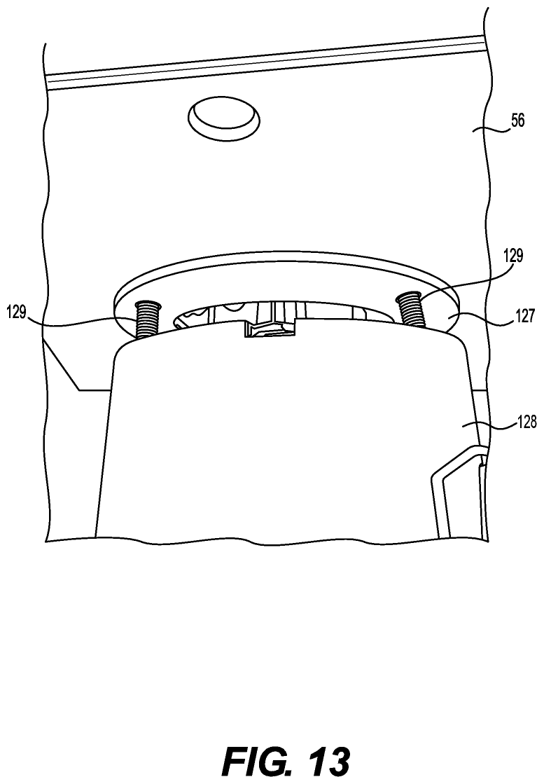

With reference to FIG. 7, the fan 32 will be described in more detail. As can be seen, the fan 32 is disposed in the lower portion of the housing 22. The fan 32 is mounted to the fan support 56. The fan 32 has a fan housing 121 connected to the top of the fan support 156. The fan housing 121 defines a fan inlet 122. A frustoconical air collector 124 is connected inside the fan housing 121 below the fan inlet 122. Fan blades 126 are disposed inside the fan housing 121 below the fan inlet 122 and the air collector 124, and above the fan support 56. The air collector 124 directs air from the air inlet 122 toward the fan blades 126. In the present embodiment, the fan blades 126 are rearward swept fan blades made from polyamide, but other types of fan blades 126 are contemplated. The fan blades 126 are driven by an electric fan motor 128 that is mounted to the bottom of the fan support 56, so as to be suspended from the fan support 56 above the bottom 44 of the housing 22. With reference to FIG. 13, a ring 127 is disposed between the fan motor 128 and the fan support 56. The ring 127 is made from polytetrafluoroethylene (PTFE), such as Teflon™. It is contemplated that the ring 127 could be made of other types of electrically insulating material. The fasteners 129 used to fasten the motor 128 to the fan support 56 pass through the ring 127 and through corresponding apertures (not shown) in the fan support 56. Sleeves (not shown) made from PTFE or other electrically insulating material are provided in the apertures in the fan support 56 around the fasteners 129. As a result, the motor 128 and the fasteners 129 are electrically insulated from the rest of the air filtration unit 20. In the present embodiment, the fan motor 128 is a totally enclosed fan-cooled (TEFC) one horsepower electric motor. In one embodiment, the fan motor 128 is a MaxMotion™ MTR-102FDCH electric motor. Other types of motors are contemplated. In one embodiment, this fan motor 128 in combination with the other components of the filtration unit 20 provide an airflow of 330 L/s at the inlet of the hood 26.

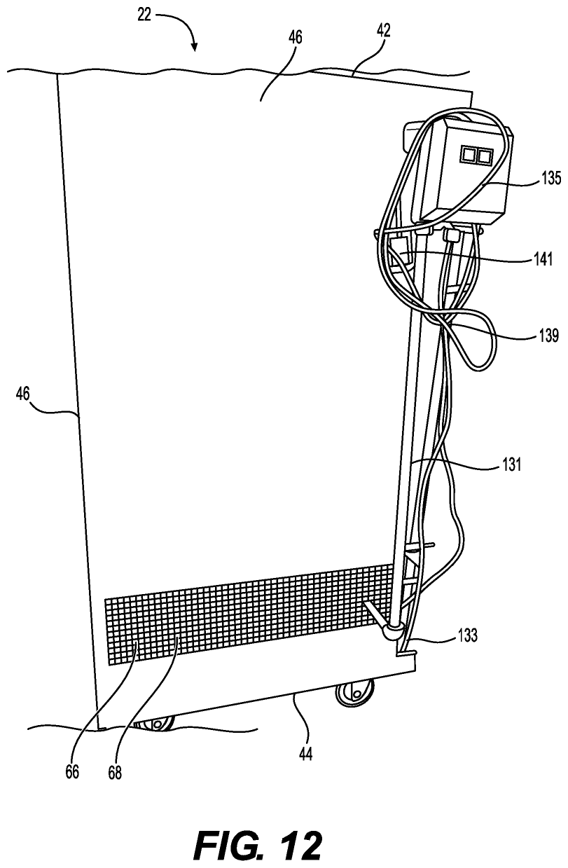

With reference to FIGS. 10 to 12, a power cable 131 of the fan motor 128 extend through an aperture defined in the right side wall 46 of the housing 22 below the fan support 56 and the right air outlet 66. A grommet assembly 133 is provided in the aperture between the power cable 131 and the right side wall 46 of the housing 22 to electrically insulate the power cable 131 from the housing 22. The power cable 131 extends upward outside the housing 22 and connects to a manual electric starter 135 mounted by a bracket 137 to an upper front portion of the right side wall 46. In one embodiment, the electric starter 135 is a GV2ME16 manual starter provided in a GV2MCO2 (IP55) housing both from Schneider Electric™. In some embodiments, the electric starter 135 is provided with a power indicator light. Other types of starters are contemplated. The starter 135 is mounted to the bracket 137 so as to be electrically insulated from the housing 22. An electric cable 139 having a male plug 141 (FIG. 12) is connected to the starter 135. In one embodiment, the electric cable 139 is an SJTOW cable and the plug 141 is a hospital grade plug such as a model 8215-PLC plug from Leviton™ which provides a power indication light. Other types of cables and plugs are contemplated. It is contemplated that the above electric component could be provided on the left side of the housing 22. The fan motor 128 is powered by plugging the plug 141 in a 120V wall power outlet. In some embodiment, an additional electric ground is connected to the fan motor 128. It is contemplated that in alternative embodiment, the fan motor 128 could be powered by a battery pack provided outside the housing 22. In some embodiments, the housing 22 is permanently electrically grounded.

Left and right baffle walls 130 are connected to the bottom of the fan support 56 and extend vertically downwardly therefrom. As such, the baffle walls 130 are vertically below the fan blades 126. The left baffle wall 130 is disposed laterally between the fan motor 128 and the left air outlet 66. The right baffle wall 130 is disposed laterally between the fan motor 128 and the right air outlet 66. The lower ends of the baffles walls 130 are vertically lower than the air outlets 66. Air flowing from the fan blades 126 flows generally downward inside the baffle walls 130, then flows generally outward under the lower ends of the baffle walls, then flows generally upward outside the baffle walls 130, and then flows out of the housing 22 via the air outlets 66. The baffle walls 130, in addition to providing a circuitous path for the air, help reduce the amount of fan noise that is transmitted out of the housing 22 via the air outlets 66. With reference to FIGS. 10 and 11, acoustic insulation material 143 is provided on the inner surfaces of the lower portion of the housing 22 and on the surfaces of the baffle walls 130 to further help reduce the amount of fan noise generated. In one embodiment, the acoustic insulation material is Armaflex™ elastomeric closed-cell foam from Armacell™, but other types of acoustic insulation material is contemplated. It is contemplated that the baffle walls 130 could be omitted.

Turning to FIGS. 5 to 7, the doors 34, 36, 38 will be described in more detail. The doors 34, 36, 38 are removable from the housing 22 in the present embodiment. However, it is contemplated that the doors 34, 36, 38 could be hinged to the housing 22. Removing the door 34 provides access to and permits the replacement of the filter 28. Removing the door 36 provides access to the filter 30, the filter frame 110, and the lifting assembly 114, thus permitting replacement of the filter 30. Removing the door 36 also provides access to the fan housing 121 which can be removed to provide access to the fan blades 126. Removing the door 38 provides access to the fan motor 128 and the baffle walls 130. For each of the doors 34, 36, 38, four threaded posts 132 extend from a front of the housing 22 (only some of which are labeled in the Figures for clarity). One post 132 is provided for each corner of the corresponding door 34, 36, or 38. The posts 132 are disposed externally of the compressible joints 58, 60. Each door 34, 36, 38 has corresponding holes in its four corners. To close the door 34, the door 34 is placed on the housing 22 such that the posts 132 extend through the holes in the corners of the door 34. Then, four internally threaded knobs 134 (only some of which are labeled in the Figures for clarity) are threaded onto the posts 132 and are tightened until the compressible joint 58 is compressed between the door 34 and the housing 22. The doors 36, 38 are closed in the same manner. It is contemplated that other devices could be used for closing the doors 34, 36, 38. It is contemplated that two or all three of the doors 34, 36, 38 could be combined as a single door. The doors 34, 36, 38 are made of stainless steel, but other materials are contemplated.

In an alternative embodiment, it is contemplated that the air outlets 66 could be blocked or omitted, and that the door 38 could define and air outlet. In such an embodiment, a flange is provided around the air outlet. A flexible pipe is mounted at one end to this flange. The other end of the flexible pipe is connected to an air outlet of the room in which the filtration unit 20 is provided, such as an operating room, to expel the filtered air out of the room. As a result, when the filtration unit 20 is operating, a negative pressure is created inside the room (i.e. pressure lower than outside the room) thus helping to prevent airborne contaminants from escaping the room. In another alternative embodiment, one of the air outlets 66 is blocked or omitted and the other air outlet 66 is provided with a flange to permit the attachment of such a flexible tube. It is contemplated that a rigid pipe could be mounted to the flange instead of the flexible pipe. It is contemplated that in such an embodiment, the articulated tube assembly 24 could be removed and that a grille could be provided over the air inlet 62 such that the filtration unit 20 operates to create negative pressure inside the room.

During operation of the fan 32, air flows sequentially through the hood 26, then through the articulated tube assembly 24, then through the air inlet 62 into the upper portion of the housing 22, then through the filter 28, then through the filter 30, then through the fan 32, and then out of the housing 22 via the air outlets 66. The operation of the fan 32 creates a negative pressure (i.e. pressure lower than outside the housing 22) in the portion of the housing 22 where the filters 28, 30 are located, thus preventing dust, aerosols and spray droplets from escaping the housing.

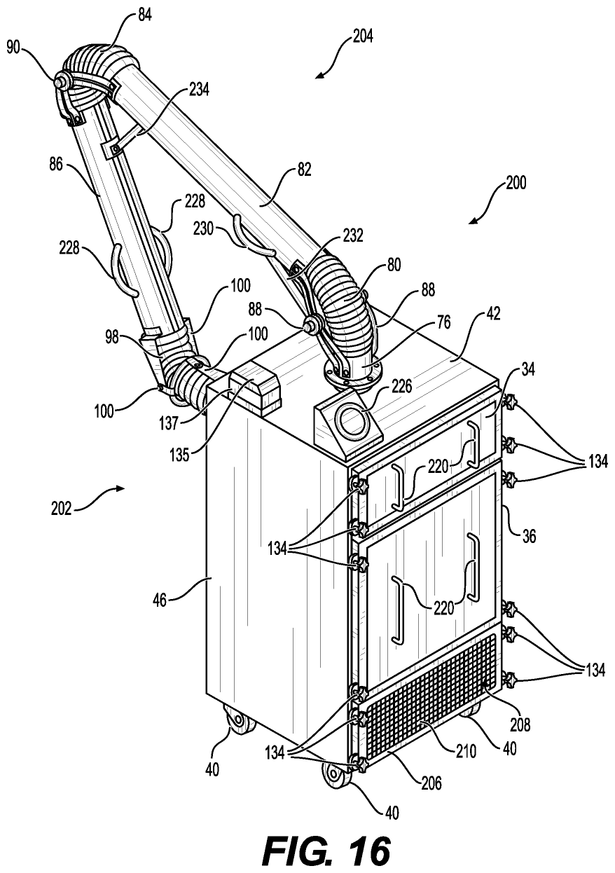

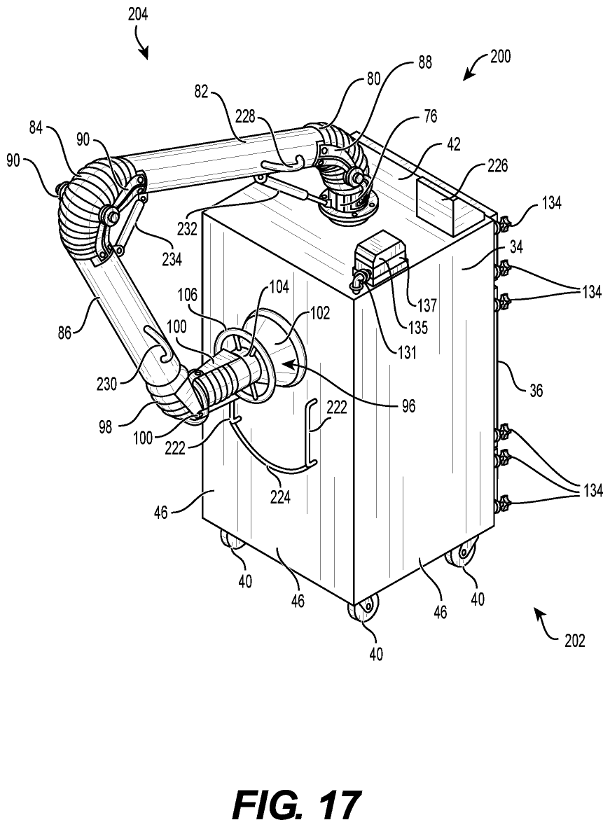

Turning now to FIGS. 16 and 17, a filtration unit 200 will now be described in more detail. The filtration unit 200 is an alternative embodiment of the filtration unit 20 and has many of the same or similar features. As such, for simplicity, these features have been labeled with the same reference numerals and will not be described again. The filtration unit 200 has a housing 202 and an articulated tube assembly 204. Also, unless specifically recited below, the internal components of the filtration unit 200 (i.e. filters 28, 30, fan 32, etc.) are the same as or similar to those described above with respect to the filtration unit 20.

The filtration unit 200 does not have air outlets 66 defined in the lower portion of the side walls 46. Instead, the lower door 38 has been replaced with a door 206 that defines an air outlet 208. The air outlet 208 has a grille 210 disposed therein. As with the air outlets 66, the air outlet 208 if vertically below the filters 28, 30 and the fan 32.

To provide a circuitous air path for the air flowing from the fan 32 to the air outlet 208 and to help reduce the amount of fan noise that is transmitted out of the housing 202 via the air outlets 208, the baffle walls 130 of the filtration unit 20 have been replaced with a baffle wall (not shown) extending laterally in the lower portion of the housing 202. This baffle wall is connected to the bottom of the fan support 56 and extends vertically downwardly therefrom. This baffle wall is disposed longitudinally between the fan motor 128 and the air outlet 208. It is contemplated that the baffle wall could be omitted.

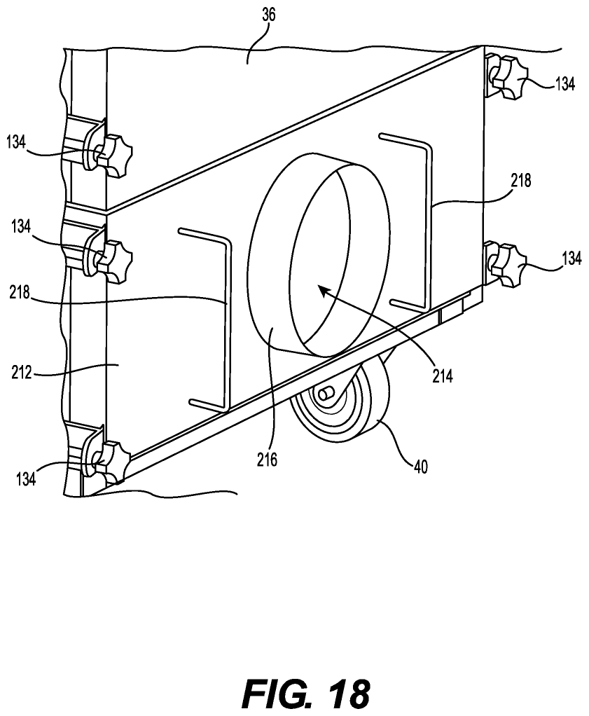

As shown in FIG. 18, the door 206 can be replaced with a door 212 defining an air outlet 214. A flange 216 is provided around the air outlet 214. A flexible pipe (not shown) is mounted at one end to this flange 216. The other end of the flexible pipe is connected to an air outlet of the room in which the filtration unit 200 is provided, such as an operating room, to expel the filtered air out of the room. As a result, when the filtration unit 200 is operating, a negative pressure is created inside the room (i.e. pressure lower than outside the room) thus helping to prevent airborne contaminants from escaping the room. It is contemplated that a rigid pipe could be mounted to the flange 216 instead of the flexible pipe. Handle 218 are mounted to the door 212 on either side of the flange 216 to facilitate the installation and removal of the door 212. It is contemplated that the handles 216 could be omitted. It is contemplated that in such an embodiment, the articulated tube assembly 204 could be removed and that a grille could be provided over the air inlet 62 such that the filtration unit 200 operates to create negative pressure inside the room.

Handles 220 are mounted to the doors 34 and 36 to facilitate the installation and removal of the door 34, 36. Handles 222 (FIG. 17) are also mounted to the back wall 46 of the housing 202 to help in the positioning of the housing 202 in the room where the filtration unit 200 is to be used. An arcuate bar 224 extends between the lower ends of the handles 222. The arcuate bar 224 and the handles 222 together define a rack where the hood 96 against which the hood 96 can rest when not being used. It is contemplated that one or more, or even all, of the handles 220, 222 and the arcuate bar 224 could be omitted. It is also contemplated that the filtration unit 20 described above could be provided with one or more of the handles 220, 222 and the arcuate bar 224.

As can be seen in FIGS. 16 and 17, in the filtration unit 200, the electric starter 135 is mounted to the top 42 of the housing 202, more specifically on the rear, right corner of the top 42. The power cable 131 passes through the top 42 of the housing 202.

A differential pressure gauge 226 is mounted to the top 42 of the housing 202, more specifically on the front, right corner of the top 42. The differential pressure gauge 226 is used to determine the air pressure upstream and downstream of the filter 30 during operation of the filtration unit 200 to determine when the filter 30 needs to be replaced. Other types of sensors which could be used to determine when the filter 30 needs replacement are also contemplated. It is contemplated that a similar arrangement could be used to determine when the filter 28 needs to be replaced. It is also contemplated that the air pressure comparison could be made between the air pressure upstream of the filter 28 and the air pressure downstream of the filter 30.

The articulated tube assembly 204 is similar to the articulated tube assembly 94. In the articulated tube assembly 204, the handles 92, 95 have been replaced by handles 228 disposed on opposite sides of the rigid tube 86. A handle 230 is also provided on the rigid tube 82. A gas cylinder 232 is connected between the rotating socket 76 and the rigid tube 82. Another gas cylinder 234 is connected between the rigid tube 82 and the rigid tube 86. The gas cylinders 232 and 234 help to stabilize the articulated tube assembly 204. It is contemplated that one or both of the gas cylinders 232 could be omitted. It is also contemplated that one or more of the handles 228, 230, the gas cylinder 232 and the gas cylinder 234 could be provided on the articulated tube assembly 24 and the articulated tube assembly 94.

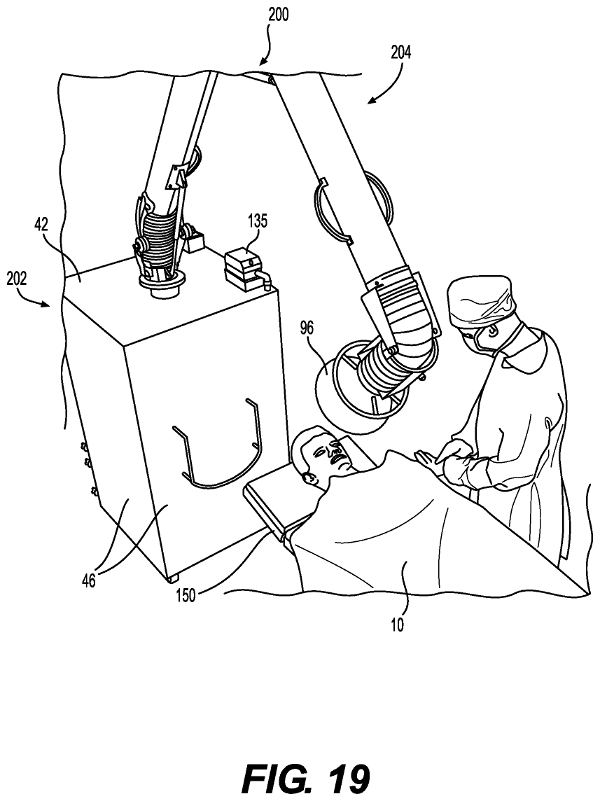

A method for aspirating infectious aerosols and spray droplets 12 (FIG. 2) expelled from a patient's mouth using the filtration unit 200 having the articulated tube assembly 204 will now be described. With reference to FIG. 19, in one embodiment the filtration unit 200 is placed next to the bed 150 of the patient 10 such that the rear wall 46 of the housing 202 faces the bed 150. As would be understood from the above description, the rear wall 46 of the housing 202 is free of any components and apertures. As such, the rear wall 46 of the housing 202 forms a solid, flat surface that can be easily cleaned. The fan 32 is first powered. Then the hood 96 is located near a head of the patient 10 as shown for creating a low pressure region 136 (FIG. 2) around the head of the patient 10. In some embodiments, the hood 96 is located between 12 and 18 inches from the head of the patient 10. It is contemplated that the fan 32 could be powered after the hood 96 has been located near the head of the patient 10. As a result, air from the region 136 is aspirated such that air flows sequentially through the hood 96, then through the articulated tube assembly 204, then through the air inlet 62 into the upper portion of the housing 202. Should the patient 10 cough or sneeze, infectious aerosols and spray droplets 12 expelled from the mouth of the patient 10 will be aspirated from the region 136 with the air as shown in FIG. 2, thus preventing these infectious aerosols and spray droplets 12 from spreading into the room where the patient 10 is located. The infectious aerosols and spray droplets 12 are then filtered out of the air using the filters 28, 30 as air flows generally downward through the filters 28, 30 from the upper portion of the housing 202 to the fan 32. The filtered air flowing from the fan 32 is then expelled out of the housing 202 via the air outlet 208. A method for aspirating infectious aerosols and spray droplets 12 expelled from a patient's mouth using the filtration unit 20 having the articulated tube assembly 24 and the hood 26 or the articulated tube assembly 94 and the hood 96 is similar to the one described above.

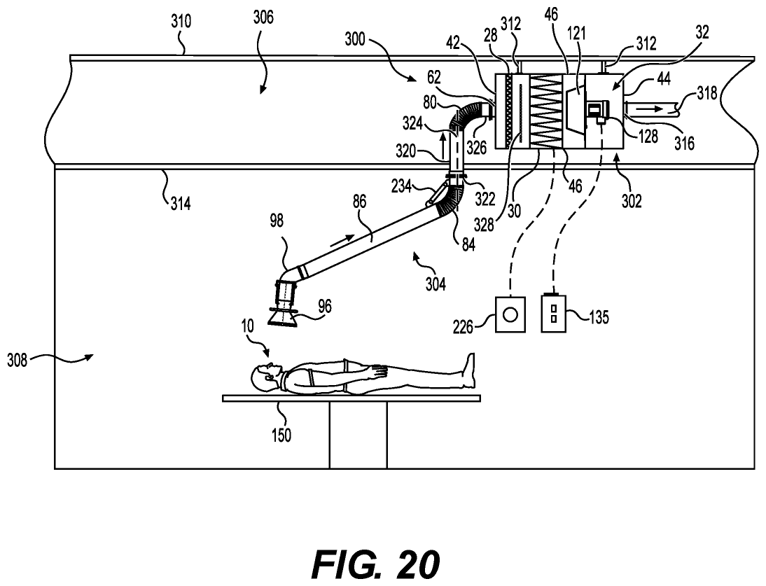

Turning now to FIG. 20, the filtration unit 300 will now be described in more detail. The filtration unit 300 is an alternative embodiment of the filtration unit 200 and has many of the same or similar features. As such, for simplicity, these features have been labeled with the same reference numerals and will not be described again. The filtration unit 300 has a housing 302 and an articulated tube assembly 304. Also, unless specifically recited below, the internal components of the filtration unit 300 (i.e. filters 28, 30, fan 32, etc.) are the same as or similar to those described above with respect to the filtration unit 20.

As can be seen, the housing 302 is disposed on its side compared to the housing 202 of the filtration unit 200. As such, although reverence numerals 42, 44 and 46 have been used to label the walls of the housing 302 since they correspond or are similar to the walls 42, 44 and 46 of the housing 202, it should be understood that in the housing 302 the walls 42 and 44 are side walls, one of the walls 46 is the top and one of the walls 46 is the bottom. The housing 302 is oriented as shown to take less space vertically to allow mounting of housing 302 inside an interstitial space 306 of a room 308 where the filtration unit 300 is to be provided. It is contemplated that the room 308 could be an exam room, a procedure room or an operating room for example. The housing 302 is mounted to the top 310 of the interstitial space 306 by legs 312 connected to the top 46 of the housing 302. It is also contemplated that the housing 302 could be mounted to the bottom 314 of the interstitial space 306 by legs similar to legs 312. It is also contemplated that the housing 302 could sit on the bottom 314 of the interstitial space 306 either directly or with a vibration damping pad provided between the housing 302 and the bottom 314 of the interstitial space 306. It is also contemplated that the legs 312 could be replaced by another type of brackets or mounting structure. It is also contemplated that the housing 302 could be mounted between the structural ceiling and a dropped ceiling of a room. It is also contemplated that in rooms that do not have an interstitial space 306, the housing 302 could be mounted to the ceiling or a wall of the room.

The filtration unit 300 is provided with the doors 32 and 34 like the filtration unit 200, but the door 206 of the filtration unit 200 has been replaced with the door 38 of the filtration unit 20. As such the door 38 does not provide an air outlet. The walls 46 also do not provide air outlets. Instead, an air outlet 316 is defined in the side wall 44. The air outlet 316 is connected to a rigid or flexible pipe 318 which is connected to a ventilation system of the building. It is contemplated that the pipe 318 could alternatively exhaust into another room, outside the building or inside the interstitial space 306. It is also contemplated that the pipe 318 could be omitted such that the air outlet 316 exhausts directly inside the interstitial space 306. It is also contemplated that instead of being defined in the side wall 44, the air outlet could be defined in one or more of the three walls 46 downstream of the fan 32. It is also contemplated that instead of being defined in the side wall 44, the door 38 could be replaced with the door 212 described above to define the air outlet 316.

In the illustrated embodiment, the doors 34, 36, 38 providing access to the internal components of the housing 302 (i.e. filters 28, 30, fan 32, etc.) are located on the side of the housing 302. It is contemplated that depending of the orientation in which the housing 302 is mounted and on the space available to remove and install the doors and the filters 28, 30, that the doors 34, 36, 38 could also be located on the top or the bottom.

In the filtration unit 300, the articulated tube assembly 204 of the filtration unit 200 has been replaced by an articulated tube assembly 304. As can be seen, the articulated tube assembly 304 is connected to the air inlet 62 of the housing 302 and extends through the bottom 314 of the interstitial space 306. To facilitate installation of the articulated tube assembly 304, the rigid tube 82 of the articulated tube assembly 204 has been replaced with a rigid tube 320 and a rotating socket 322. The rigid tube 320 connects to the flexible hose 80 and extends vertically through the bottom 314 of the interstitial space 306. The rotating socket 322 connects to the lower end of the rigid tube 320. The rotating socket 322 permits 360 degrees of rotation of the hood 96 and of the portions of the articulated tube assembly 304 located below the bottom 314 of the interstitial space 306 (i.e. elements 84, 86, 98, 234) about a vertical axis 324. It is contemplated that the rotating socket 322 could also permit vertical movement of the hood 96 and of the portions of the articulated tube assembly 304 located below the bottom 314 of the interstitial space 306. It is contemplated that the rotating socket 322 could be omitted in some embodiments. As the housing 302 is fixedly connected and the rigid tube 320 is held in position by the bottom 314 of the interstitial space 306, the rotating socket 76 of the articulated tube assembly 204 has been replaced by a connection tube 326 that provides a rigid connection in the articulated tube assembly 304. For the same reasons, the gas cylinder 232 of the connection tube assembly 204 has been omitted in the articulated tube assembly 304. It is also contemplated that the flexible hose 80 could be replaced by a rigid elbow. Other components of the articulated tube assembly 304 are similar to those of the articulated tube assembly 204 and will therefore not be described again.

In the filtration unit 300, the pre-filter 28 and the filter 30 are more spaced apart from each other than in the filtration unit 200. An ultraviolet (UV) light 328 is provided in the housing 302 in the space between the pre-filter 28 and the filter 30 to assist in sterilization. It is contemplated that UV lights could also be provided elsewhere inside the housing 302.

As the housing 302 is provided in the interstitial space 306, the starter 135 is not provided on the housing 302. Instead, the starter 135 is provided in the room 308 on a wall or at another location where it can be accessed and is electrically connected to the motor 128. Similarly, the differential pressure gauge 226 is not provided on the housing 302. Instead, the differential pressure gauge 226 is provided in the room 308 on a wall or at another location where it can be read and is in communication with the housing 302.

A method for aspirating infectious aerosols and spray droplets 12 (FIG. 2) expelled from a patient's mouth using the filtration unit 300 having the articulated tube assembly 304 will now be described. The hood 96 is located near a head of the patient 10 as shown for creating a low pressure region 136 (FIG. 2) around the head of the patient 10. In some embodiments, the hood 96 is located between 12 and 18 inches from the head of the patient 10. It is contemplated that the fan 32 could be powered after the hood 96 has been located near the head of the patient 10. As a result, air from the region 136 is aspirated such that air flows sequentially through the hood 96, then through the articulated tube assembly 304, then through the air inlet 62 into the housing 302. Should the patient 10 cough or sneeze, infectious aerosols and spray droplets 12 expelled from the mouth of the patient 10 will be aspirated from the region 136 with the air as shown in FIG. 2, thus preventing these infectious aerosols and spray droplets 12 from spreading into the room 308. The infectious aerosols and spray droplets 12 are then filtered out of the air using the filters 28, 30 as air flows generally laterally through the filters 28, 30 from one side of the housing 302 to the fan 32. The filtered air flowing from the fan 32 is then expelled out of the housing 302 via the air outlets 316, and then flows through the pipe 318.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A filtration unit for aspirating infectious aerosols and spray droplets expelled from a patient's mouth, the filtration unit comprising:
a housing defining an air inlet, the air inlet being defined in an upper portion of the housing;
an articulated tube assembly having a first end fluidly connected to the air inlet;
a hood connected to a second end of the articulated tube assembly;
a fan disposed in a lower portion of the housing; and
at least one filter disposed in the housing vertically above the fan, vertically above at least one air outlet defined in a lower portion of the filtration unit, and vertically below the air inlet,
the at least one filter being disposed fluidly between the air inlet and the at least one air outlet,
during operation of the fan, air flowing sequentially through the hood, then through the articulated tube assembly, then through the air inlet into the upper portion of the housing, then through the at least one filter, then through the fan, and then out of the housing via the at least one air outlet.

2. The filtration unit of claim 1, wherein:
the housing has a top, a bottom and a plurality of side walls;
the air inlet is defined in the top of the housing; and
the at least one air outlet is defined in at least one side wall of the plurality of side walls.

3. The filtration unit of claim 2, wherein:
the at least one air outlet is two air outlets; and
the two air outlets are defined in opposite side walls of the plurality of side walls.

4. The filtration unit of claim 2, wherein the first end of the articulated tube assembly is connected to the top of the housing.

5. The filtration unit of claim 4, wherein:
the first end of the articulated tube assembly includes a rotating socket;
the rotating socket is connected to the top of the housing; and
the rotating socket permits 360 degrees of rotation of the articulated tube assembly about a vertical axis relative to the housing.

6. The filtration unit of claim 1, wherein the articulated tube assembly comprises:
first, second and third flexible hoses; and
first and second rigid tubes,
the first rigid tube is connected between the first and second flexible hoses,
the second rigid tube is connected between the second and third flexible hoses, and
the hood is connected to the third flexible hose.

7. The filtration unit of claim 6, further comprising a handle connected to one of the second rigid tube, the third flexible hose and the hood.

8. The filtration unit of claim 6, wherein the articulated tube assembly further comprises:
at least one first self-locking joint connecting the first rigid tube to the first end of the articulated tube assembly, the at least one self-locking joint being disposed externally of the first rigid tube and the first flexible hose; and
at least one second self-locking joint connecting the first rigid tube to the second rigid tube, the at least one second self-locking joint being disposed externally of the first rigid tube, the second flexible hose and the second rigid tube.

9. The filtration unit of claim 1, wherein the fan comprises:
a fan housing defining a fan inlet;
fan blades disposed below the fan inlet; and
a fan motor disposed below the fan blades, the fan motor being operatively connected to the fan blades.

10. The filtration unit of claim 9, further comprising acoustic insulation disposed in the lower portion of the housing.

11. The filtration unit of claim 9, further comprising at least one baffle wall extending vertically below the fan blades; and
wherein a lower end of the at least one baffle wall is vertically lower than the at least one air outlet such that air flowing from the fan blades flows generally downward inside the at least one baffle wall, then flows generally outward under the lower end of the at least one baffle wall, then flows generally upward outside the at least one baffle wall, and then flows out of the housing via the at least one air outlet.

12. The filtration unit of any one of claims 1 to 11, wherein:
the at least one filter includes a first filter and a second filter; and
the first filter is disposed vertically above the second filter.

13. The filtration unit of claim 12, wherein:
the first filter is a pre-filter; and
the second filter is one of a high-efficiency particulate air (HEPA) filter and an ultra-low particulate air (ULPA) filter.

14. The filtration unit of claim 12, further comprising:
a filter frame disposed in the housing, the second filter being disposed in the filter frame;
a flange disposed in the housing above the filter frame;
a compressible joint connected to one of a top of the filter frame and a bottom of the flange; and
a lifting assembly moving the filter frame between a lowered position and a raised position,
in the raised position, the compressible joint being compressed between the filter frame and the flange.

15. The filtration unit of any one of claims 1 to 11, wherein the housing defines at least one access port for providing access to the fan and the at least one filter; and
the filtration unit further comprises:
at least one door for selectively closing the at least one access port; and
at least one compressible joint connected to one of the housing and the at least one door,
when the at least one door is closed, the at least one compressible joint surrounds the at least one access port and is compressed between the at least one door and the housing.

16. The filtration unit of any one of claims 1 to 11, wherein the housing defines at least one access port for providing access to the fan and the at least one filter; and
the filtration unit further comprises at least one door for selectively closing the at least one access port;
wherein the at least one air outlet is defined in one of the at least one door.

17. The filtration unit of claim 16, further comprising a flange around the at least one air outlet, the flange being configured for connecting a pipe to the filtration unit.

18. The filtration unit of any one of claims 1 to 11, further comprising at least one grille disposed in the at least one air outlet.

19. The filtration unit of any one of claims 1 to 11, further comprising a plurality of wheels mounted to a bottom of the housing.

20. A method for aspirating infectious aerosols and spray droplets expelled from a patient's mouth using a filtration unit, the filtration unit comprising:
a housing defining an air inlet;
an articulated tube assembly having a first end fluidly connected to the air inlet;
a hood connected to a second end of the articulated tube assembly;
a fan disposed in the housing; and
at least one filter disposed in the housing vertically above the fan;
the method comprising:
powering the fan;
locating the hood near a head of the patient for creating a low pressure region around the head of the patient;
aspirating air from the region such that air flows sequentially through the hood, then through the articulated tube assembly, then through the air inlet into the upper portion of the housing;
filtering infectious aerosols and spray droplets out of the air using the at least one filter as air flows generally downward through the at least one filter from the upper portion of the housing to the fan disposed in a lower portion of the housing; and
expelling the filtered air flowing from the fan out of the housing via at least one air outlet defined in a lower portion of the filtration unit.

21. A filtration unit for aspirating infectious aerosols and spray droplets expelled from a patient's mouth, the filtration unit comprising:
a housing defining an air inlet;
an articulated tube assembly having a first end fluidly connected to the air inlet;
a hood connected to a second end of the articulated tube assembly;
a fan disposed in a lower portion of the housing; and
at least one filter disposed in the housing vertically above the fan, the at least one filter being disposed vertically between the air inlet and at least one air outlet defined in the filtration unit, the at least one filter being disposed fluidly between the air inlet and the at least one air outlet,
during operation of the fan, air flowing sequentially through the hood, then through the articulated tube assembly, then through the air inlet into the housing, then through the at least one filter, and then out of the housing via the at least one air outlet.

22. The filtration unit of claim 21, wherein:
the housing has a top, a bottom and a plurality of side walls;
the air inlet is defined in the top of the housing; and
the at least one air outlet is defined in at least one side wall of the plurality of side walls.

23. The filtration unit of claim 22, wherein:
the at least one air outlet is two air outlets; and
the two air outlets are defined in opposite side walls of the plurality of side walls.

24. The filtration unit of claim 22, wherein the first end of the articulated tube assembly is connected to the top of the housing.

25. The filtration unit of claim 21, further comprising a handle connected to the articulated tube assembly.

26. The filtration unit of claim 21, wherein the articulated tube assembly has 360 degrees of rotation about a vertical axis relative to the housing.

27. The filtration unit of claim 21, wherein the articulated tube assembly comprises:
first and second rigid tubes;
at least one first self-locking joint operatively connecting the first rigid tube to the second rigid tube; and
at least one second self-locking joint operatively connecting the second rigid tube to the hood.

28. The filtration unit of claim 21, wherein the fan comprises:
a fan housing defining a fan inlet;
fan blades disposed below the fan inlet; and
a fan motor disposed below the fan blades, the fan motor being operatively connected to the fan blades.

29. The filtration unit of claim 28, further comprising acoustic insulation disposed in the lower portion of the housing.

30. The filtration unit of claim 28, further comprising at least one baffle wall extending vertically below the fan blades; and
wherein a lower end of the at least one baffle wall is vertically lower than the at least one air outlet such that air flowing from the fan blades flows generally downward inside the at least one baffle wall, then flows generally outward under the lower end of the at least one baffle wall, then flows generally upward outside the at least one baffle wall, and then flows out of the housing via the at least one air outlet.

31. The filtration unit of any one of claims 21 to 30, wherein:
the at least one filter includes a first filter and a second filter; and
one of the first and second filters is disposed vertically above the other one of the first and second filters.

32. The filtration unit of claim 31, wherein:
the first filter is a pre-filter; and
the second filter is one of a high-efficiency particulate air (HEPA) filter and an ultra-low particulate air (ULPA) filter.

33. The filtration unit of claim 31, further comprising:
a filter frame disposed in the housing, the second filter being disposed in the filter frame;
a flange disposed in the housing above the filter frame;
a compressible joint connected to one of a top of the filter frame and a bottom of the flange; and
a lifting assembly moving the filter frame between a lowered position and a raised position,
in the raised position, the compressible joint being compressed between the filter frame and the flange.

34. The filtration unit of any one of claims 21 to 30, wherein the housing defines at least one access port for providing access to the fan and the at least one filter; and
the filtration unit further comprises:
at least one door for selectively closing the at least one access port; and
at least one compressible joint connected to one of the housing and the at least one door,
when the at least one door is closed, the at least one compressible joint surrounds the at least one access port and is compressed between the at least one door and the housing.

35. The filtration unit of any one of claims 21 to 30, wherein the housing defines at least one access port for providing access to the fan and the at least one filter; and
the filtration unit further comprises at least one door for selectively closing the at least one access port;
wherein the at least one air outlet is defined in one of the at least one door.

36. The filtration unit of claim 35, further comprising a flange around the at least one air outlet, the flange being configured for connecting a pipe to the filtration unit.

37. The filtration unit of any one of claims 21 to 30, further comprising at least one grille disposed in the at least one air outlet.

38. The filtration unit of any one of claims 21 to 30, further comprising a plurality of wheels operatively connected to a bottom of the housing.

39. A method for aspirating infectious aerosols and spray droplets expelled from a patient's mouth using a filtration unit, the filtration unit comprising:
a housing defining an air inlet;
an articulated tube assembly having a first end fluidly connected to the air inlet;
a hood connected to a second end of the articulated tube assembly;
a fan disposed in a lower portion of the housing; and
at least one filter disposed in the housing vertically above the fan;
the method comprising:
powering the fan;
locating the hood near a head of the patient for creating a low pressure region around the head of the patient;
aspirating air from the region such that air flows sequentially through the hood, then through the articulated tube assembly, then through the air inlet;
filtering infectious aerosols and spray droplets out of the air using the at least one filter as air flows generally vertically through the at least one filter; and
expelling the filtered air flowing from the at least one filter out of the housing via at least one air outlet defined in the filtration unit.

40. A filtration unit for aspirating infectious aerosols and spray droplets expelled from a patient's mouth, the filtration unit comprising:
a housing defining an air inlet;
an articulated tube assembly having a first end fluidly connected to the air inlet;
a hood connected to a second end of the articulated tube assembly;
a fan disposed in the housing; and
at least one filter disposed in the housing,
the air inlet being disposed on a first side of the at least one air filter,
the fan being disposed on a second side of the at least one air filter,
an air outlet being defined in a portion of the filtration unit downstream of the fan and on the second side of the at least one filter,
the at least one filter being disposed fluidly between the air inlet and the at least one air outlet,
during operation of the fan, air flowing sequentially through the hood, then through the articulated tube assembly, then through the air inlet into the housing, then through the at least one filter, then through the fan, and then out of the housing via the at least one air outlet.

41. The filtration unit of claim 40, wherein:
the housing has a top, a bottom and a plurality of side walls;
the air inlet is defined in a first wall of the plurality of side walls; and
the at least one air outlet is defined in a second side wall of the plurality of side walls.

42. The filtration unit of claim 41, wherein the first and second side walls are opposite to each other.

43. The filtration unit of claim 41, wherein the first end of the articulated tube assembly is connected to the first side wall.

44. The filtration unit of claim 43, further comprising a rotating socket configured for connecting at least a portion of the articulated tube assembly to at least one of a ceiling and a bottom portion of an interstitial space,
the rotating socket permitting 360 degrees of rotation of at least the portion of the articulated tube assembly about a vertical axis.

45. The filtration unit of claim 40, wherein the articulated tube assembly comprises:
first and second flexible hoses; and
first and second rigid tubes,
the first rigid tube is connected to the first flexible hose,
the second rigid tube is connected between the first and second flexible hoses, and
the hood is connected to the second flexible hose.

46. The filtration unit of claim 45, further comprising a handle connected to one of the second rigid tube and the hood.

47. The filtration unit of claim 40, wherein the fan comprises:
a fan housing defining a fan inlet;
fan blades disposed downstream of the fan inlet; and
a fan motor disposed downstream of the fan blades, the fan motor being operatively connected to the fan blades.

48. The filtration unit of claim 47, further comprising acoustic insulation disposed in the portion of the housing housing the fan.

49. The filtration unit of any one of claims 40 to 48, wherein:
the at least one filter includes a first filter and a second filter; and
the first filter is disposed between the second filter and the air inlet.

50. The filtration unit of claim 49, wherein:
the first filter is a pre-filter; and
the second filter is one of a high-efficiency particulate air (HEPA) filter and an ultra-low particulate air (ULPA) filter.

51. The filtration unit of any one of claims 40 to 48, wherein the housing defines at least one access port for providing access to the fan and the at least one filter; and
the filtration unit further comprises:
at least one door for selectively closing the at least one access port; and
at least one compressible joint connected to one of the housing and the at least one door,
when the at least one door is closed, the at least one compressible joint surrounds the at least one access port and is compressed between the at least one door and the housing.

52. The filtration unit of any one of claims 40 to 48, wherein the housing is adapted for mounting to at least one of a ceiling, a top of an interstitial space and the bottom of the interstitial space.

53. The filtration unit of claim 52, further comprising at least one bracket for connecting the housing to the at least one of the ceiling, the top of the interstitial space and the bottom of the interstitial space.

54. The filtration unit of claim 52, wherein the housing is adapted for mounting to the at least one of the top of the interstitial space and the bottom of the interstitial space, such that the housing is disposed in the interstitial space and at least a portion of the articulated tube assembly extends in a room below the interstitial space.
